(19) United States
(12) Patent Application Publication
(10) Pub. No.: US 2016/0123015 A1
(43) Pub. Date: May 5, 2016

(54) SLIP RESISTANT SHEET MATERIAL FOR ROOFING AND METHOD OF MANUFACTURING THE SAME

(71) Applicants: David Granovsky, Toronto (CA); Steve Lombardi, Cambridge (CA); Sylvain Jutras, Drummondville (CA)

(72) Inventors: David Granovsky, Toronto (CA); Steve Lombardi, Cambridge (CA); Sylvain Jutras, Drummondville (CA)

(21) Appl. No.: 14/529,116

(22) Filed: Oct. 30, 2014

(51) Int. Cl. E04D 12/00; B32B 38/06

(52) U.S. Cl. CPC E04D 12/002; B32B 38/06

(57) ABSTRACT

The present document describes a slip resistant sheet material for roofing having a thickness and being adapted for a worker to walk thereon in his footwear. The slip resistant sheet material comprises a base layer and a thermoplastic layer affixed to the base layer. The base layer and the thermoplastic layer define projections and corresponding depressions transversely to the thickness of the slip resistance material whereby, when the worker walks on the slip resistant sheet material, there exists friction between the footwear and a combination comprising the projections and the thermoplastic layer thereby providing slip resistance.

### BACKGROUND

(a) Field

The subject matter disclosed generally relates to slip resistant sheet materials for roofing and to methods for manufacturing slip resistant sheet materials for roofing. More particularly, the subject matter disclosed relates to a weather-resistive barrier for a roofing structure, and especially to a reinforced roof underlayment having a slip resistant feature.

(b) Related Prior Art

Roofing structures for buildings typically include an underlayment positioned between a roof support deck and an overlayment. The overlayment, such as asphalt shingles, tiles, wooden shakes, slate tiles metal roofing, or the like is intended to provide protection from external weather conditions like wind, rainwater, and snowmelt. In order to further protect against moisture and other elements which may pass under the overlayment, the underlayment is installed over the roof deck and under the underlayment to provide an added waterproof barrier. The additional moisture protection provided by the underlayment is particularly necessary with tile roofs, where gaps often exist between the tiles where moisture can pass through. The underlayment also serves the function of providing a seal around roofing fasteners used to affix the tiles to the roof support deck.

Typically, underlayment may include a polymeric material that is affixed and/or coated to a base sheet for providing a barrier to weather conditions. A limitation of such underlayment is that these polymeric materials can be very slippery in both wet and dry conditions. Installation of the underlayment and the subsequent roofing material can therefore be problematic as workers may need to walk across or work upon the polymeric material coated or affixed to the base sheet. This decreases the commercial attractiveness of such underlayment for high pitch roof applications or in climates characterized by wet or humid conditions.

Accordingly, there is a need for a roofing underlayment having an improved resistance to deterioration from exposure to external elements which prevents a person from slipping while moving about on the roofing underlayment and for an improved method of manufacturing the same.

### SUMMARY

According to an embodiment, there is provided a slip resistant sheet material for roofing having an upper side and a lower side. The slip resistant sheet material comprises: a closed-weave woven base layer having a top surface facing in a same direction as the upper side; and a first thermoplastic layer affixed to the top surface; wherein projections are formed in the same direction as the upper side at corresponding locations in the base layer and the first thermoplastic layer thereby providing slip resistance on the upper side.

According to an aspect, the projections are defined on the upper side and corresponding depressions are defined on the lower side.

According to an aspect, the slip resistant sheet material has a thickness and wherein the projections and corresponding depressions are defined transversely to the thick of the slip resistant sheet material.

According to an aspect, the slip resistant sheet material is adapted for a worker to walk thereon in his footwear and whereby, when the worker walks or stands on the slip resistant sheet material, there exists friction between the footwear and a combination comprising the projections and the first thermoplastic layer thereby providing slip resistance.

According to an aspect, the closed-weave woven base layer further comprises a bottom surface opposite the top surface and the slip resistant sheet material further comprises a second thermoplastic layer affixed to the bottom surface.

According to an aspect, the first thermoplastic layer and the second thermoplastic layer are respectively directly affixed to the top surface and to the bottom surface without use of an adhesive or another intermediate layer.

According to an aspect, at least one of the first thermoplastic layer and the second thermoplastic layer is vapor impermeable.

According to an aspect, at least one the first thermoplastic layer and the second thermoplastic layer is a film-forming polymer.

According to an aspect, at least one the first thermoplastic layer and the second thermoplastic layer comprise(s) at least one of: polyethylene and polypropylene.

According to an embodiment, there is provided a method for manufacturing a slip resistant sheet material for roofing having an upper side and a lower side. The method comprises: providing a closed-weave woven base layer having a top surface facing in a same direction as the upper side; affixing a first thermoplastic layer to the top surface; and after affixing first thermoplastic layer to the top surface, embossing the base layer and the first thermoplastic layer to form projections in the same direction as the upper side at corresponding locations in the base layer and the first thermoplastic layer thereby providing slip resistance on the upper side.

According to an aspect, the embossing is performed at ambient temperature.

According to an aspect, the embossing comprises embossing the base layer and the first thermoplastic layer with an engraved roller.

According to an aspect, the closed-weave woven base layer further comprises a bottom surface opposite the top surface and the method further comprises affixing a second thermoplastic layer to the bottom surface.

According to an aspect, the affixing the first thermoplastic layer and the second thermoplastic layer comprises respectively directly affixing the first thermoplastic layer and the second thermoplastic layer to the top surface and to the bottom surface without use of an adhesive or another intermediate layer.

According to an aspect, the affixing the first thermoplastic layer and the second thermoplastic layer comprises respectively extruding a film-forming polymer thereby producing the first thermoplastic layer and the second thermoplastic layer.

According to an aspect, the method further comprises respectively bonding the first thermoplastic layer and the second thermoplastic layer with the top surface and to the bottom surface.

According to an aspect, the extruding a film-forming polymer comprises extruding at least one of: polyethylene and polypropylene.

According to an embodiment, there is provided a slip resistant sheet material for roofing having a thickness and being adapted for a worker to walk thereon in his footwear. The slip resistant sheet material comprises: a base layer; and a thermoplastic layer affixed to the base layer; wherein the base layer and the thermoplastic layer define projections and corresponding depressions transversely to the thickness of the slip resistance sheet material and whereby, when the worker walks or stands on the slip resistant sheet material, there exists friction between the footwear and a combination comprising the projections and the thermoplastic layer thereby providing slip resistance.

The following terms are defined below.

The term “slip resistant sheet material” is intended to mean a sheet material provided with an additional means for increasing the slip resistance and thereby increasing safety of those walking on roofs, or on any surfaces, on which the slip resistance sheet material is installed before installation of an overlayment.

The term “closed-weave woven” is intended to mean yarns or threads that are normally tightly interlaced at a right angle to form a fabric or a sheet material. The method in which these yarns or threads are interwoven affects the characteristics of the fabric or of the sheet material. The yarns or threads that are tightly interlaced may also be at an angle different than the right angle.

The term “thermoplastic layer” is intended to mean an elastic and flexible layer, made of a thermoplastic material, to be affixed to at least one of the top surface and bottom surface of a closed-weave woven. The “thermoplastic layer” may provide a weather-resistant barrier which prevents moisture and other external elements from passing through the slip resistant sheet material.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is an elevation view of a slip resistant sheet material for roofing in accordance with an embodiment;

FIG. 2 is an enlarged, fragmentary, cross-sectional view of the slip resistant sheet material for roofing of FIG. 1;

FIG. 2a is another enlarged, fragmentary, cross-sectional view of the slip resistant sheet material for roofing of FIG. 1;

FIG. 2b is yet another enlarged, fragmentary, cross-sectional schematic view of the slip resistant sheet material for roofing of FIG. 1;

FIG. 2c is an enlarged, fragmentary, cross-sectional schematic view of the slip resistant sheet material for roofing where only the base layer and the first thermoplastic layer are present;

FIG. 3 is an exploded, perspective view of the slip resistant sheet material for roofing of FIG. 1;

FIG. 4 is an elevation view of a slip resistant sheet material for roofing in accordance with another embodiment;

FIG. 5 illustrates a method for manufacturing a slip resistant sheet material for roofing in accordance with another embodiment;

FIG. 6 is a perspective view of slip resistant sheet materials for roofing being installed on an exemplary roof structure in accordance with another embodiment;

FIG. 7 is a perspective view showing the slip resistant sheet materials for roofing of FIG. 6 in a later stage of the installation process; and

FIG. 8 illustrates a process for manufacturing a slip resistant sheet material for roofing in accordance with another embodiment.

It will be noted that throughout the appended drawings, like features are identified by like reference numerals.

### DETAILED DESCRIPTION

There is disclosed herein various embodiments of a slip resistant sheet material for roofing and of a method for manufacturing a slip resistant sheet material for roofing.

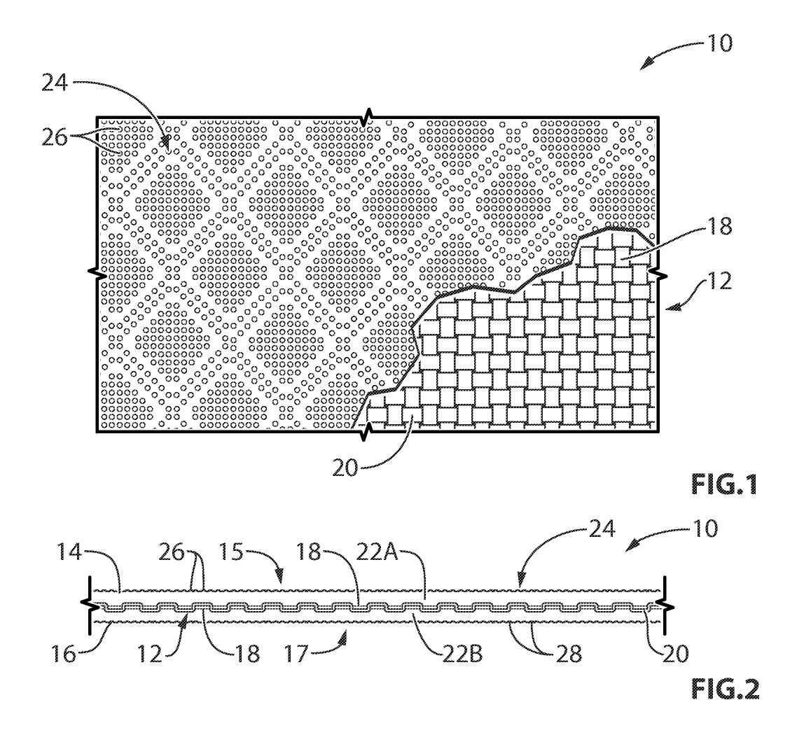

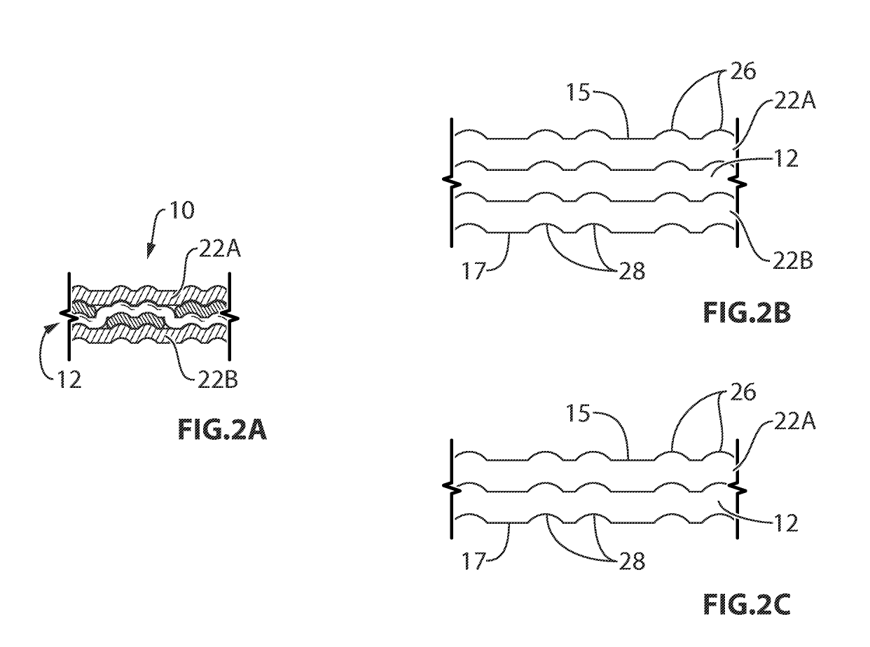

Referring now to the drawings, and more particularly to FIG. 1, there is shown an elevation view of a slip resistant sheet material 10 for roofing in accordance with an embodiment. The slip resistant sheet material 10 for roofing has an upper side 15 and a lower side 17. The slip resistant sheet material 10 for roofing further includes a base layer 12 which defines a top surface 14 and a bottom surface 16 (FIG. 2). The top surface 14 faces in a same direction as the upper side 15.

According to an embodiment, base layer 12 comprises a closed-weave woven which is referred herein to as a closed-weave woven base layer 12. According to another embodiment, the base layer 12 comprises a non-woven fibrous material such as a spunbond polyester substrate.

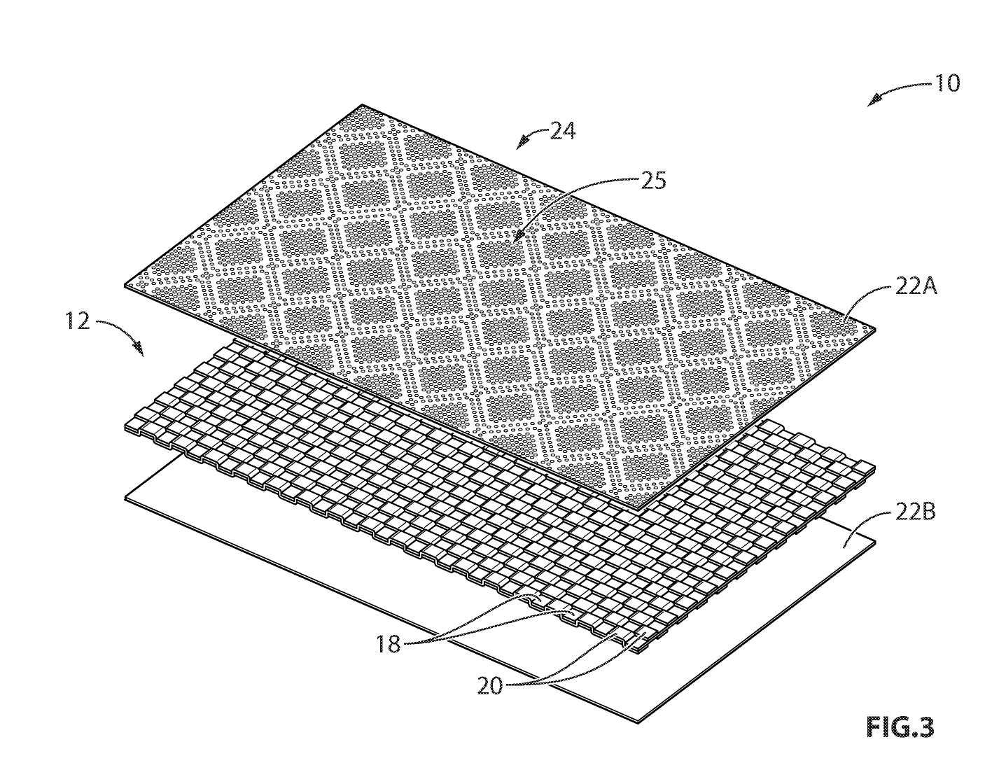

According to an embodiment, the closed-weave woven base layer 12 includes yarns of a first direction 18 and yarns of a second direction 20 that are interspersed with the yarns of the first direction 18. As better shown in FIGS. 2, 2a, 2b and 2c, which is an enlarged, fragmentary, cross-sectional view of the slip resistant sheet material 10 for roofing of FIG. 1, and in FIG. 3, which is an exploded, perspective view of the slip resistant sheet material 10 for roofing of FIG. 1, the slip resistant sheet material 10 for roofing further includes thermoplastic first and second layers 22A, 22B respectively affixed to the top surface side 14 and the bottom surface 16 of the closed-weave woven base layer 12 for providing a weather-resistant barrier. Still referring to FIGS. 2, 2a and 3, there is shown that a first thermoplastic layer 22A is affixed to the top surface 14 of the closed-weave woven and a second thermoplastic layer 22B is affixed to the bottom surface 16 of the closed-weave woven base layer 12.

As shown in FIGS. 1-3, the closed-weave woven base layer 12 and the first and second thermoplastic layers 22A, 22B are embossed to form an embossed pattern 24. The embossed pattern 24 has a plurality of projections 26 that outwardly extends from the first thermoplastic layer 22A and a plurality of corresponding depressions 28 that inwardly extends from the second thermoplastic layer 22B for providing slip resistance. The projections 26 of the embossed pattern 24 along with the first thermoplastic layer 22A provide an anti-skid surface/enhanced friction surface/slip resistant surface.

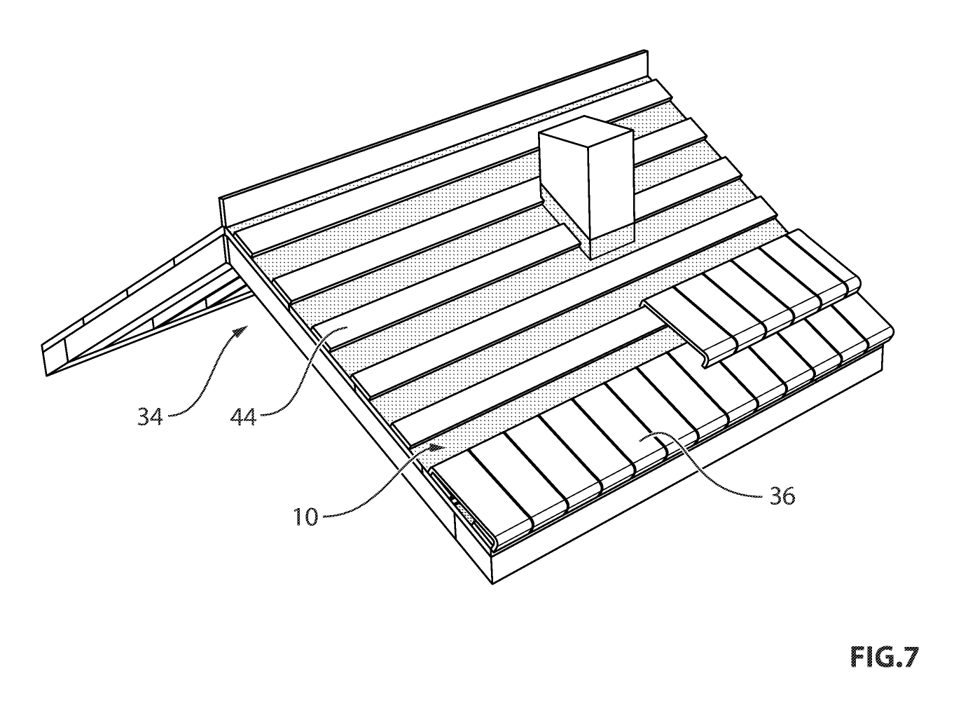

The embossed pattern 24 increases the slip resistance and thereby increasing safety of those walking on roofs on which the slip resistant sheet material 10 is installed before installation of an overlayment 36 (FIG. 7).

According to FIGS. 1-3, there is shown that the plurality of projections 26 and the plurality of corresponding depressions 28 are regularly spaced within the embossed pattern 24 such as to define a specific mosaic or pattern, such as pattern 25. However, it is to be noted that the plurality of projections 26 and the plurality of corresponding depressions 28 may be irregularly spaced within the embossed pattern 24 as long as it increases the slip resistance and thereby increases safety of those walking on roofs on which the slip resistant sheet material 10 is installed before installation of the overlayment 36.

The embossed pattern 24 includes a texture formed by a plurality of features that are raised and or sunken with respect to the closed-weave woven base layer 12 and the first and second thermoplastic layers 22A, 22B. For example, the texture can include a plurality of protrusions or projections 26 and a plurality of corresponding depressions 28 (i.e., cavities, voids) in the closed-weave woven base layer 12 and the first and second thermoplastic layers 22A, 22B. The texture of the embossed pattern 24 may be of varying heights or depths or can be substantially the same height or depth. Example of heights and depths of the texture include between about 0.01 mm to 10 mm. The texture can be disposed randomly or can be configured as a uniform or repeated pattern, such as pattern 25. Where the texture is disposed as an array of uniform or repeating configurations, examples may include straight lines, a cross-hatch pattern, a chevron pattern, a checked pattern, a company logo, dots, and the like. The texture can include raised and/or sunken features that are adjacent to each other or spaced apart from each other providing various densities. Examples include where the texture includes between 1 feature to 100 features per cm² of the slip resistant sheet material 10. Additionally, the features of the texture can have the same shape or can have varying shapes such as square, triangular, circular, ovular, obround, rectangular, random, or any other suitable shape configured to form the anti-skid surface.

In accordance with embodiments, the slip resistant sheet material 10 may include only one thermoplastic layer, a first and a second thermoplastic layers, or a plurality of different thermoplastic layers, some providing weather-resistant barrier, some other providing UV-resistant barrier, microbial properties, heat resistant properties and the like. It is to be noted that all the thermoplastic layers and the closed-weave woven base layer 12 need to be embossed to form the embossed pattern 24. This configuration will provide the safety of those walking on roofs.

In accordance with an embodiment, the thermoplastic layer or the plurality of thermoplastic layers 22A, 22B may include a film-forming polymer.

In accordance with an embodiment, the thermoplastic layer or the plurality of thermoplastic layers 22A, 22B comprise(s) polyethylene, polypropylene or a mixture of polyethylene and polypropylene.

In accordance with an embodiment, the yarns of the first direction 18 and the yarns of the second direction 20 are substantially flat, but can adopt any other cross-sectional configurations.

The thermoplastic layers 22A, 22B (first thermoplastic layer 22A and second thermoplastic layer 22B) are normally affixed to both the upper and the top surface 14 and the bottom surface 16 of the closed-weave woven base layer 12, as shown in the slip resistant sheet material 10 for roofing of FIGS. 2 and 3.

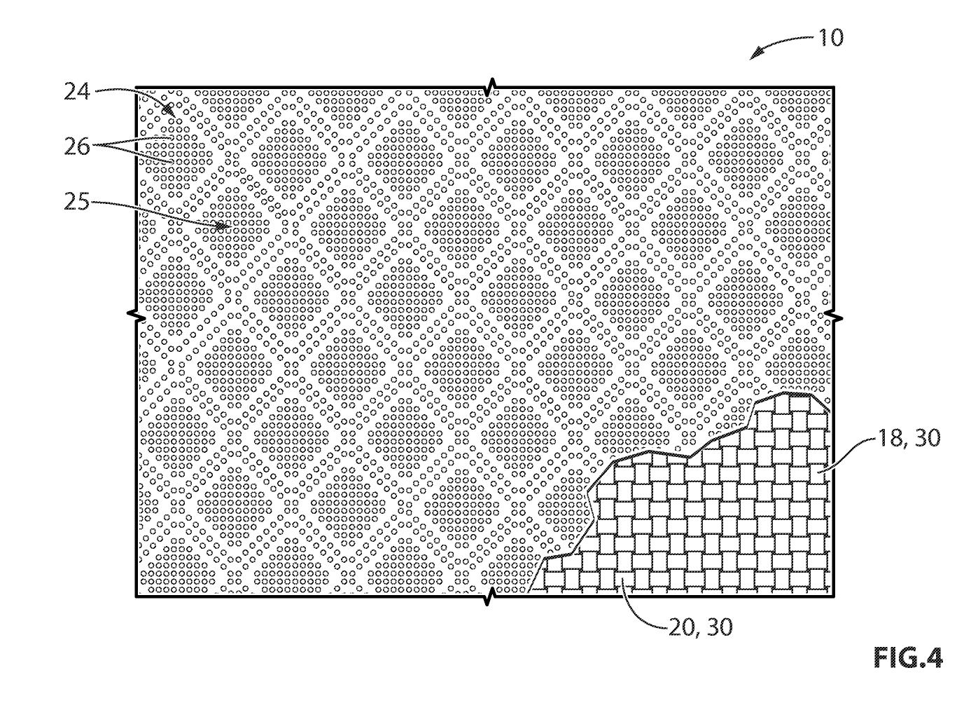

Now referring to FIG. 4 and in accordance with another embodiment, the closed-weave woven base layer 12 may be formed of yarns of a first gauge 30 of material having a tensile strength sufficient to resist tearing when exposed to tensile loads from various directions. The yarns of the first gauge 30 are normally the yarns of the first direction 18 and the yarns of the second direction 20. More specifically, the slip resistant sheet material 10 for roofing includes the closed-weave woven base layer 12, which includes yarns of the first direction 18 and yarns of the second direction 20. The closed-weave woven base layer 12 may further includes yarns of a second gauge 32, interspersed within the closed-weave woven base layer 12 with the yarns of the first direction 18 (as shown in FIG. 4) and/or with the yarns of the second direction 20. The yarns of the second gauge 32 include a gauge that is greater than the first gauge. As better shown in FIG. 4, the yarns of the second gauge 32 are interspersed in the closed-weave woven base layer 12 at a given interval with the yarns of the first direction 18.

In accordance with an embodiment, the yarns of the second gauge 32 of the closed-weave woven base layer 12 are parallel to each other. In the closed-weave woven base layer 12, the spacing between the parallel yarns of the second gauge is substantially equal. The yarns of the second gauge 32 of the closed-weave woven base layer 12 may also be perpendicular to each other.

Still referring to FIG. 4, there is shown an elevation view of the closed-weave woven base layer 12 of the slip resistant sheet material 10 for roofing in accordance with an embodiment. In FIG. 4, a first group of yarns of the first gauge are in a first direction (yarns of the first direction 18), a second group of yarns of the first gauge are in a second direction (yarns of the second direction 20) perpendicular to the first direction and a third group of yarns of the second gauge 32 are in the direction parallel to the yarns of the first direction 18. Also, the yarns of the second gauge 32 may be interspersed at the given interval in at least one of the first and second directions for providing an additional slipping resistance in addition to the embossed pattern 24 for preventing a person from slipping while moving on the slip resistant sheet material 10 for roofing. It is to be noted that the given interval is a multiple of 18 yarns in an embodiment, as shown in FIG. 4 and referred to as X1. In other embodiments the multiple may be 6 yarns, 9 yarns, 12 yarns, 15 yarns, 36 yarns, 72 yarns, 90 yarns, or any given interval of yarns (not shown) such as to further prevent slipping from a worker. Thus, according to different embodiments, the given interval may be a multiple of any suitable number.

In accordance with an embodiment, the given interval may be a mix of at least two given intervals. For instance, for allowing a worker to walk on a roofing structure without sliding, the slip resistant sheet material 10 for roofing may include a first group of three yarns of the second gauge 32 interspersed at a given interval of 6 yarns of the yarns of the first direction 18 in the closed-weave woven base layer 12 and another yarn of the second gauge 32, distant from the first group of three yarns of the second gauge 32, at another given interval of 72 yarns of the yarns of the first direction 18.

According to another embodiment, the given interval is one of: a regular given interval and an irregular given interval. As another example, a first group of three yarns of the second gauge 32 may intersperse the closed-weave woven base layer 12 at a first quarter of the closed-weave woven base layer 12, a second group of three yarns of the second gauge 32 may intersperse the closed-weave woven base layer 12 at a first half of the closed-weave woven base layer 12 and a third group of three yarns of the second gauge 32 may intersperse the closed-weave woven base layer 12 at a second quarter of the closed-weave woven base layer 12.

It is also to be noted that the yarns of the first direction 18 and the yarns of the second direction 20 are tightly interwoven. The yarns of the first direction 18 and the yarns of the second direction 20 of the closed-weave woven base layer 12 may be formed of a thermoplastic polymer, such as polypropylene, polyethylene, polyester, nylon or other similar materials. However, it is to be noted that the yarns of the first direction 18 and the yarns of the second direction 20 of the closed-weave woven base layer 12 may be of any suitable material that has strength sufficient to resist tearing when exposed to tensile loads from various directions.

The yarns of the first direction 18 and the yarns of the second direction 20 are interwoven as shown in FIGS. 1-4, by way of example, to provide a closed-weave woven base layer 12 having an improved tensile strength not achievable with solid film of material. The orientation of the yarns of the first direction 18 and the yarns of the second direction 20 may also be selected to optimize their tensile strength.

The yarns of the first gauge 30 (i.e., the yarns of the first direction 18 and the yarns of the second direction 20) and the yarns of the second gauge 32 may comprise any cross-sectional shape and size, depending upon the desired tensile characteristics of the closed-weave woven base layer 12. For example, the yarns of the first gauge 30 may be interwoven fibers as shown in FIG. 2, may be cross-laminated polyethylene tape, or may include any other interwoven configuration. The size of the yarn of the first gauge 30 may be approximately between 800 Denier to 1,000 Denier. The size of the yarn of the second gauge 32 may be approximately between 1,000 Denier and 12,000 Denier. However, the size of the yarns of the first gauge 30 and the size of the yarns of the second gauge 32 may be of any suitable size allowing the formation of a tight closed-weave woven base layer 12.

Referring to FIGS. 2 and 3, the first and second thermoplastic layers 22A, 22B affixed to both the top surface 14 and the bottom surface 16 of the closed-weave woven base layer 12 provide a weather-resistant barrier which prevents moisture and other external elements from passing through the slip resistant sheet material 10 for roofing. An exemplary embodiment for the first and second thermoplastic layers 22A, 22B includes a layer of thermoplastic film which is extruded over each side of the closed-weave woven base layer 12, so that the closed-weave woven base layer 12 is sandwiched between the first and the second thermoplastic layers 22A, 22B.

The slip resistant sheet material 10 for roofing is shown as having a thermoplastic layer 22A or 22B positioned over each side of the closed-weave woven base layer 12. However, it is understood that certain applications may allow the closed-weave woven base layer 12 to have only one side coated with a thermoplastic layer. The thermoplastic layer(s) (such as first and second thermoplastic layers 22A, 22B) may include polyethylene, polypropylene, or other similar thermoplastic polymers.

The slip resistant sheet material 10 for roofing is formed by extruding layers of thermoplastic polymer over the closed-weave woven base layer 12. According to an embodiment, the first and the second thermoplastic layers 22A, 22B are directly affixed to the base layer without use of an adhesive or another intermediate layer.

According to another embodiment, the thermoplastic layers may be affixed to the closed-weave woven base layer 12 using an adhesive or any other manner of attachment.

The thermoplastic layers (i.e., such as first and second thermoplastic layers 22A, 22B) may be variably pigmented to allow the color of the thermoplastic layers to be selected based upon particular requirements. The thickness of the thermoplastic layers is selected such that the slip resistant sheet material 10 for roofing is flexible, whereby the flexible nature of the slip resistant sheet material 10 for roofing allows it to be formed into rolls and easily installed by simply unrolling the slip resistant sheet material 10 for roofing over a roof support structure or the like.

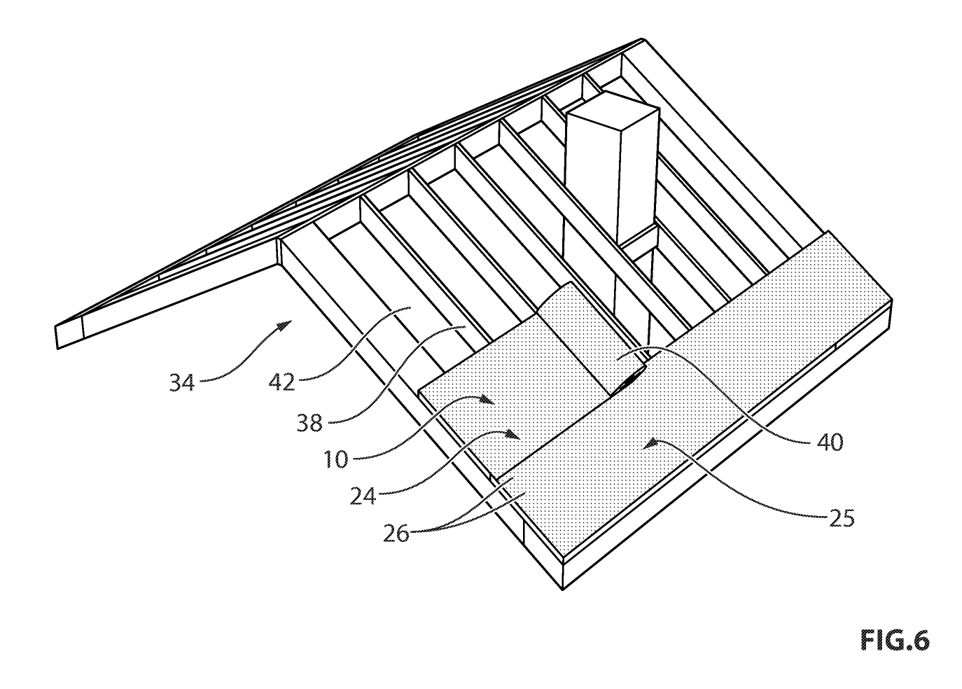

The slip resistant sheet material for roofing 10 may be installed between a roof support structure 34 (FIG. 6) and an overlayment 36 (FIG. 7) in order to provide a waterproof barrier for the roof structure. The slip resistant sheet material 10 for roofing may be mechanically fastened to the roof rafters 38 (FIG. 6) using nails or screws, but it is understood that the slip resistant sheet material 10 for roofing may be affixed to the roof rafters 38 using adhesives or other possible attachment methods.

The slip-resistant sheet material 10 for roofing may be formed from a plurality of thermoplastic layers having an improved resistance to deterioration from exposure to external elements, such as moisture and dirt, so that the slip resistant sheet material 10 for roofing has an improved durability and longevity. Moreover, employing closed-weave woven base layer 12 including yarns of a second gauge 32 in the slip resistant sheet material 10 for roofing provides an improved tensile strength capable of being walked upon without tearing when being installed on the roof. The closed-weave woven base layer 12 further provides improved strength to resist tearing when exposed to external forces, such as collected moisture, wind, and other external forces.

As shown, the improved resistance to deterioration and tearing provided by the slip resistant sheet material for roofing 10 improves the integrity and effectiveness of the weather-resistant barrier provided by the slip resistant sheet material for roofing 10. By improving the longevity of the waterproof integrity of the slip resistant sheet material for roofing 10 to more closely match the integrity of the entire roof structure, the longevity of the integrity of the entire roof structure is improved.

According to an embodiment, and referring now to FIG. 6, there is shown a perspective view of the slip resistant sheet material 10 for roofing being installed on an exemplary roof structure. The slip resistant sheet material 10 for roofing is to be installed between a roof support structure 34 and an overlayment 36 in order to provide a waterproof barrier and a slip resistant material for the roof structure. As shown, the slip resistant sheet material 10 for roofing may be formed into rolls 40 which can be simply unrolled over the roof support structure 34 to allow for easy installation. In this exemplary roof structure, the sarking method is utilized where the slip resistant sheet material 10 for roofing is fastened to the top side of the roof rafters 38 and allowed to drape between the open rafters bays 42. The slip resistant sheet material 10 for roofing is preferably mechanically fastened to the roof rafters 38 using nails or screws, but it is understood that the slip resistant sheet material 10 for roofing may be affixed to the roof rafters 38 using another adhesives or other possible attachment methods.

Battens 44 are then fastened over the slip resistant sheet material 10 for roofing and into the top side of the roof rafters 38, where the overlayment 36 is then attached to the battens 44, as shown in FIG. 7. The sarking method is merely one possible manner of installing a roof structure using the slip resistant sheet material 10 for roofing. For instance, the roof support structure 34 on which the slip resistant sheet material 10 for roofing is attached may include solid sheathing or spaced sheathing. Further, any type of batten structure may be attached to the slip resistant sheet material 10 for roofing for supporting the overlayment 36, such as wood battens, steel battens, plastic battens, counter-battens made from any of these materials, or the overlayment 36 may be attached directly to the roof support structure 34 through the slip resistant sheet material 10 for roofing 10.

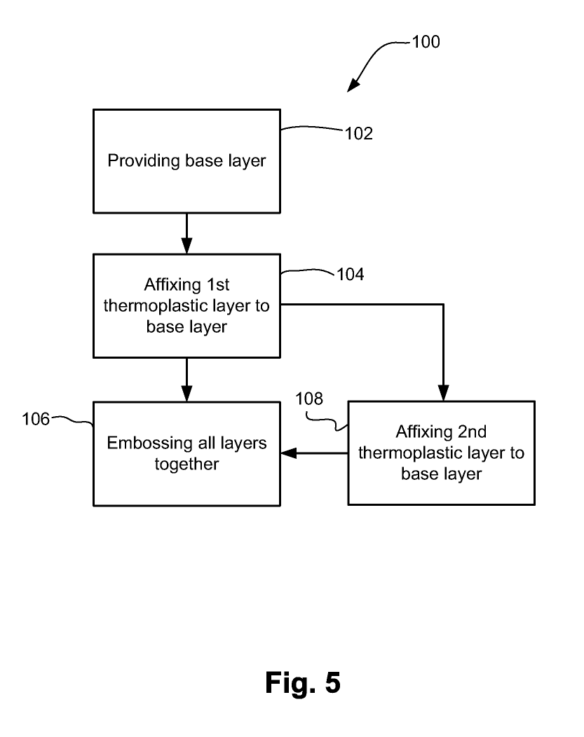

According to another embodiment and referring to FIG. 5, there is provided a method 100 for manufacturing a slip resistant sheet material 10 for roofing having an upper side and a lower side.

The method 100 comprises providing a closed-weave woven base layer having a top surface facing in a same direction as the upper side (step 102). The method 100 further comprises affixing a first thermoplastic layer to the top surface (step 104). After affixing first thermoplastic layer to the top surface, the next step is embossing the base layer and the first thermoplastic layer to form projections in the same direction as the upper side at corresponding locations in the base layer and the first thermoplastic layer (step 106) thereby providing slip resistance on the upper side.

According to an embodiment, the embossing (step 106) is performed at ambient temperature.

According to an embodiment, the embossing (step 106) comprises embossing the base layer and the first thermoplastic layer with an engraved roller.

According to an embodiment, the closed-weave woven base layer further comprises a bottom surface opposite the top surface and the method 100 further comprises affixing a second thermoplastic layer to the bottom surface (step 108).

According to an embodiment, the affixing the first thermoplastic layer and the second thermoplastic layer (steps 104 and 108) comprises respectively directly affixing the first thermoplastic layer and the second thermoplastic layer to the top surface and to the bottom surface without use of an adhesive or another intermediate layer.

According to an embodiment, the affixing the first thermoplastic layer and the second thermoplastic layer (steps 104 and 108) comprises respectively extruding a film-forming polymer (not shown) thereby producing the first thermoplastic layer and the second thermoplastic layer.

According to an embodiment, further comprising respectively bonding the first thermoplastic layer and the second thermoplastic layer to the top surface and to the bottom surface (not shown).

According to an embodiment, the extruding a film-forming polymer (step 110) comprises extruding at least one of: polyethylene and polypropylene.

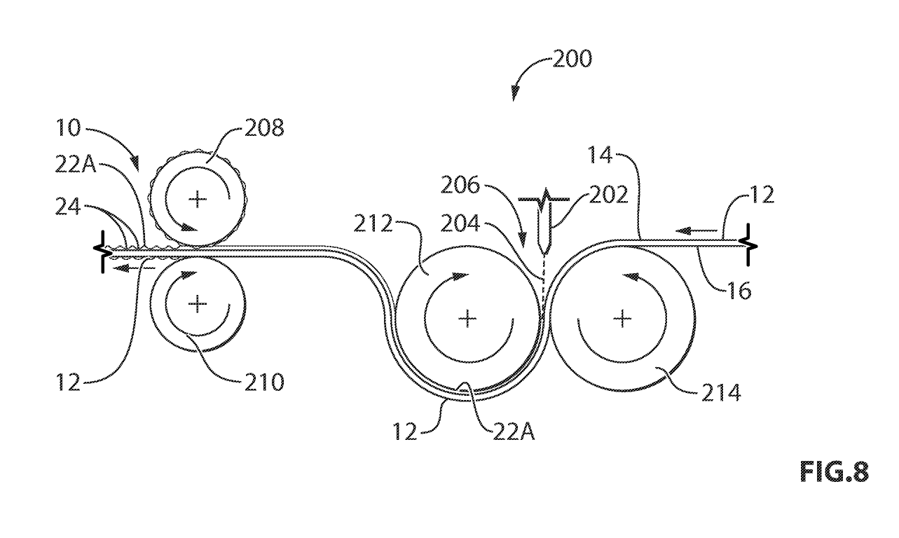

In accordance with another embodiment, there is provided a process 200 for manufacturing the slip resistant sheet material 10 for roofing. The process 200 for manufacturing the slip resistant sheet material 10 for roofing is shown in FIG. 8. First, the closed-weave woven base layer 12 is unwound into an unwinding machine for showing upwardly the top surface 14 of the closed-weave woven base layer 12. Next, a polymer film 204 is extruded through a heated die 202 to form a first thermoplastic layer 22A. The first thermoplastic layer 22A bonds to the top surface 14 of the closed-weave woven base layer 12 at the nip point 206 where at least one of rollers 212, 214 is cooled for cooling the temperature of the closed-weave woven base layer 12 which is being bonded with the first thermoplastic layer 22A. Optionally (not shown), the closed-weave woven base layer 12 is wounded and again unwound into the unwinding machine for showing upwardly the bottom surface 16 of the closed-weave woven base layer 12 . Another polymer film 204 is then extruded through the heated die 202 to form the second plastic layer 22B covering the bottom surface 16 of the closed-weave woven base layer 12. The second thermoplastic layer 22B then bonds to the bottom surface 16 of the closed-weave woven base layer 12 at the nip point 206, where at least one of rollers 212, 214 is cooled for cooling the temperature of the closed-weave woven base layer 12 which is being bonded with the second thermoplastic layer 22B. Finally, at ambient temperature, the closed-weave woven base layer 12 that is now extruded with first and/or second thermoplastic layers 22A, 22B passes through an engraved roller 208 and a backer roller 210. Using this process 200, the embossed pattern 24 is respectively cast into the first thermoplastic layer 22A, the closed-weave woven base layer 12 and alternatively, the second thermoplastic layer 22B. Since the step of passing the closed-weave woven base layer 12 through the engraved roller 208 and the backer roller 210 is performed once the closed-weave woven base layer 12 is extruded with first and second thermoplastic layers 22A, 22B, there is no need for one or both roller(s) 212, 214 to be temperature controlled to cool the polymer film extrusion and engraved to provide the embossed pattern 24.

Alternatively, instead of passing between the engraved roller 208 engraved with bump patterns 216 and the backer roller 210, the closed-weave woven base layer 12 that is extruded with or sandwiched between the first and/or second thermoplastic layers 22A, 22B, may pass under a press plate engraved with bump patterns (not shown).

The engraved roller 208 is substantially cylindrical and includes a surface configured for embossing the slip resistant sheet material 10 to form the anti-skid surface. The surface of the engraved roller 208 includes a texture formed by a plurality of features that are raised and or sunken with respect to remainder of the surface of the engraved roller 208. For example, the surface can include a plurality of protrusions from the surface of the engraved roller, a plurality of depressions in the surface of the engraved roller or both. The texture for forming the embossment on the closed-weave woven base layer 12 and on the thermoplastic layer(s) 22A and/or 22B may be of varying heights or depths or can be substantially the same height or depth. Example of heights and depths of the texture include between 0.01 mm to 10 mm. The texture can be disposed on the surface of the engraved roller 208 randomly or can be configured as a uniform or repeated pattern. Where the texture is disposed as an array of uniform or repeating configurations, examples may include straight lines, a cross-hatch pattern, a chevron pattern, a checked pattern, a company logo, dots, and the like. The texture can include raised and/or sunken features that are adjacent to each other or spaced apart from each other providing various densities. Examples include where the texture includes between 1 feature and 100 features per cm² of the surface of the engraved roller 208. Additionally, the features of the texture can have the same shape or can have varying shapes such as square, triangular, circular, ovular, obround, rectangular, random, or any other suitable shape configured to form the anti-skid surface.

Various additives may be included or applied to the slip resistant sheet material 10. Examples may include various colorants, heat stabilizers, waterproofing treatments, strengthening laminates, antimicrobials, UV blockers and light stabilizers. The slip resistant sheet material 10 may also be printed with signage, such as logos, installation instructions, and/or orientation indicia.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A slip resistant sheet material for roofing having an upper side and a lower side, the slip resistant sheet material comprising:
a closed-weave woven base layer having a top surface facing in a same direction as the upper side; and
a first thermoplastic layer affixed to the top surface;
wherein projections are formed in the same direction as the upper side at corresponding locations in the base layer and the first thermoplastic layer thereby providing slip resistance on the upper side.

2. The slip resistant sheet material of claim 1, wherein the projections are defined on the upper side and corresponding depressions are defined on the lower side.

3. The slip resistant sheet material of claim 2, wherein the slip resistant sheet material has a thickness and wherein the projections and corresponding depressions are defined transversely to the thick of the slip resistant sheet material.

4. The slip resistant sheet material of claim 1, wherein the slip resistant sheet material is adapted for a worker to walk thereon in his footwear and whereby, when the worker walks or stands on the slip resistant sheet material, there exists friction between the footwear and a combination comprising the projections and the first thermoplastic layer thereby providing slip resistance.

5. The slip resistant sheet material of claim 1, wherein the closed-weave woven base layer further comprises a bottom surface opposite the top surface and the slip resistant sheet material further comprises a second thermoplastic layer affixed to the bottom surface.

6. The slip resistant sheet material of claim 5, wherein the first thermoplastic layer and the second thermoplastic layer are respectively directly affixed to the top surface and to the bottom surface without use of an adhesive or another intermediate layer.

7. The slip resistant sheet material of claim 5, wherein at least one of the first thermoplastic layer and the second thermoplastic layer is vapor impermeable.

8. The slip resistant sheet material of claim 5, wherein at least one the first thermoplastic layer and the second thermoplastic layer is a film-forming polymer.

9. The slip resistant sheet material of claim 5, wherein at least one the first thermoplastic layer and the second thermoplastic layer comprise(s) at least one of: polyethylene and polypropylene.

10. A method for manufacturing a slip resistant sheet material for roofing having an upper side and a lower side, the method comprising:
providing a closed-weave woven base layer having a top surface facing in a same direction as the upper side;
affixing a first thermoplastic layer to the top surface; and
after affixing first thermoplastic layer to the top surface, embossing the base layer and the first thermoplastic layer to form projections in the same direction as the upper side at corresponding locations in the base layer and the first thermoplastic layer thereby providing slip resistance on the upper side.

11. The method of claim 10, wherein the embossing is performed at ambient temperature.

12. The method of claim 11, wherein the embossing comprises embossing the base layer and the first thermoplastic layer with an engraved roller.

13. The method of claim 10, wherein the closed-weave woven base layer further comprises a bottom surface opposite the top surface and the method further comprises affixing a second thermoplastic layer to the bottom surface.

14. The method of claim 13, wherein the affixing the first thermoplastic layer and the second thermoplastic layer comprises respectively directly affixing the first thermoplastic layer and the second thermoplastic layer to the top surface and to the bottom surface without use of an adhesive or another intermediate layer.

15. The method of claim 13, wherein the affixing the first thermoplastic layer and the second thermoplastic layer comprises respectively extruding a film-forming polymer thereby producing the first thermoplastic layer and the second thermoplastic layer.

16. The method of claim 15, further comprising respectively bonding the first thermoplastic layer and the second thermoplastic layer to the top surface and to the bottom surface.

17. The method of claim 15, wherein the extruding a film-forming polymer comprises extruding at least one of: polyethylene and polypropylene.

18. A slip resistant sheet material for roofing having a thickness and being adapted for a worker to walk thereon in his footwear, the slip resistant sheet material comprising:
a base layer; and
a thermoplastic layer affixed to the base layer;
wherein the base layer and the thermoplastic layer define projections and corresponding depressions transversely to the thickness of the slip resistance sheet material and whereby, when the worker walks or stands on the slip resistant sheet material, there exists friction between the footwear and a combination comprising the projections and the thermoplastic layer thereby providing slip resistance.
